(19) United States
(12) Patent Application Publication
(10) Pub. No.: US 2013/0326921 A1
(43) Pub. Date: Dec. 12, 2013

(54) THREE-DIMENSIONAL METALLIC CHARACTER AND MANUFACTURING METHOD THEREOF

(71) Applicant: Xinghua Shen, Jiangsu (CN)

(72) Inventor: Xinghua Shen, Jiangsu (CN)

(73) Assignee: WU JIANG YU XING METAL ART DECORATION CO., LTD., Jiangsu (CN)

(21) Appl. No.: 13/977,333

(22) PCT Filed: Aug. 25, 2011
(86) PCT No.: PCT/CN2011/001420

§ 371 Date: Aug. 8, 2013

(30) Foreign Application Priority Data
Dec. 31, 2010 (CN) 201010623786.4

(51) Int. Cl. G09F 13/04; G09F 7/16

(52) U.S. Cl. CPC G09F 13/0404; G09F 7/16
USPC 40/552; 40/596; 156/196

(57) ABSTRACT

The present application relates to the field of advertising lamp, in particular to a three-dimensional metallic character and the manufacturing method thereof. The three-dimensional metallic character includes: each stroke of the three-dimensional metallic character is made up by two planes which are intersecting to present a shape of mountain ridge; the ridge portion the mountain ridge constitutes the font; the ridge surface forming the mountain ridge has holes thereon; the bottom of the ridge surface forming the mountain ridge is longitudinally connected to a side surface. The three-dimensional metallic character and the manufacturing method thereof provided by the present application are novel in character structure and durable in use. When electrified in the night, the character provided herein presents eye-catching and artistic visual effect, and meanwhile beautifies urban night scene.

### TECHNICAL FIELD

The present application relates to the field of advertising lamp, in particular to a three-dimensional metallic character and the manufacturing method thereof.

### BACKGROUND ART

With the rapid development of social economy, the signboard lamp house is getting increasingly popular in most shops and public places. Such signboard lamp house not only brightens the identified characters as beautiful metallic ones in the daytime, but also presents shining metallic characters with strong stereoscopic impression in the night. In addition, the signboard lamp house is durable in use, and hence becomes a development trend of urban signboard for identifying characters. At present, the signboard lamp house generally employs conventional character with convex surface, conventional character with parallel surfaces and metallic housing for reflecting light or conventional character with metallic housing and parallel surfaces of organic glass material for emitting light at the front as basic light-emitting character, which can not present three-dimensional effect. What is worse, they even bring impressions of monotonous in style, low in grade and poor in visual effect at night, and hence cannot attract the attentions of the passers enduringly.

### SUMMARY OF THE INVENTION

### Technical Problems to Be Solved

The technical problem to be solved by this invention is to provide a three-dimensional metallic character with novel and artistic structure as well as excellent visual effect; and to provide the manufacturing method thereof.

### Technical Solution

In order to solve the aforementioned problems, one aspect of the present application provides a three-dimensional metallic character comprises: each stroke of the three-dimensional metallic character is made up by two planes which are intersecting to present a shape of mountain ridge; the ridge portion of the mountain ridge constitutes the font; the ridge surface forming the mountain ridge has holes thereon;

the bottom of the ridge surface forming the mountain ridge is longitudinally connected to a side surface.

On the other hand, the present application further provides a method of manufacturing the three-dimensional metallic character comprising:

S1, manufacturing a three-dimensional font mould of wood or PVC expansion sheet which meets the requirement of dimension scale, according to the font pattern; each stroke of the three-dimensional font mould is made up by two planes which are intersecting to present a shape of mountain ridge;

S2, dividing the three-dimensional mould, by area, into one or more area members, and marking the area members;

S3, covering each plane of the area member with rubbing material to obtain a planar deploying unit corresponding to the area member, and marking the planar deploying unit with the same identification number as that of its corresponding area member;

S4, expanding the planar deploying unit in accordance with the dimension scale in step S1;

S5, cutting the expanded planar deploying unit with a metallic plate;

S6, welding the planar deploying unit with the area member located at the same position for formation, according to the font pattern and the identification number of the area member.

### Advantageous Effect

The three-dimensional metallic character and the manufacturing method thereof provided by the present application are novel in character structure and durable in use. When electrified in the night, the character provided herein presents eye-catching and artistic visual effects, and meanwhile beautifies urban night scene.

### BRIEF DESCRIPTION OF THE DRAWINGS

FIG. 1 is a schematic view of the structure of the three-dimensional metallic character according to the present application;

FIG. 2 is another schematic view of the structure of the three-dimensional metallic character according to the present application;

FIG. 3 is a flow chart of the manufacturing method of the three-dimensional metallic character according to the present application.

### DESCRIPTION OF EMBODIMENTS

Specific embodiments of the present invention are described in details below with reference to the accompanying drawings. Such embodiments are presented herein for explaining the present application without limiting the scope thereof.

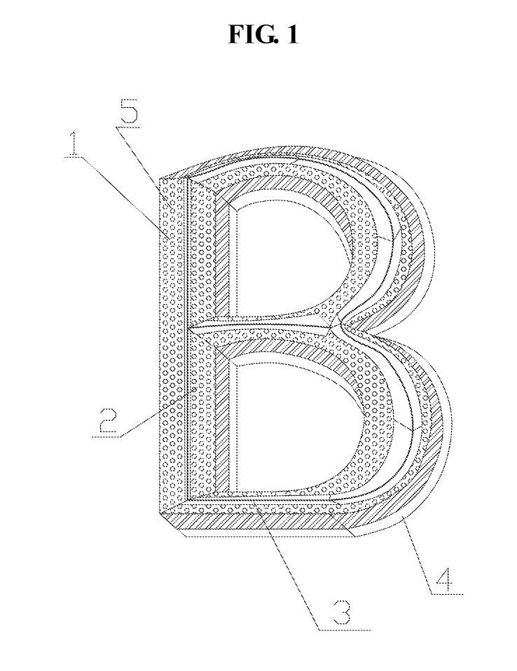

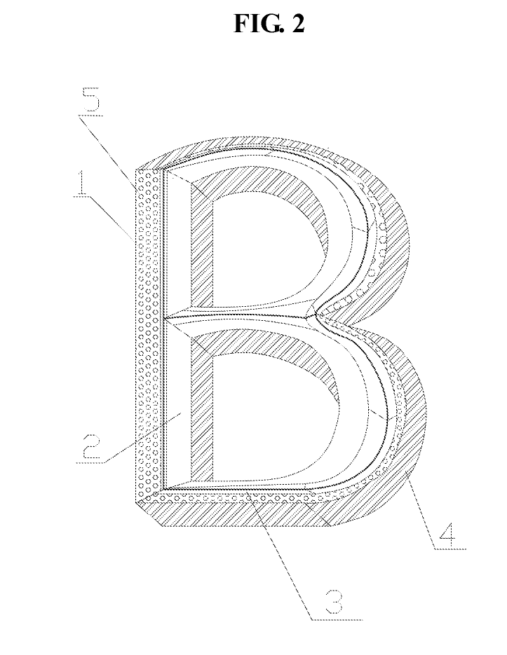

As shown in FIG. 1 and FIG. 2, the three-dimensional metallic character in the embodiment of the present application comprises: each stroke of the three-dimensional metallic character is made up by two planes which are intersecting to present a shape of mountain ridge. Taking the English letter ‘B’ as an example, each stroke of the letter ‘B’ is made up by ridge surface 1 and ridge surface 2 which are intersecting to form the shape of mountain ridge. The ridge portion 3 of the mountain ridge constitutes the font. Holes 5 are provided on partial area or whole area of the ridge surface 1 and of the ridge surface 2. The bottom of the ridge surface is longitudinally welded to the side surface 4. Preferably, holes 5 may be provided on partial area or whole area of the side surface 4, wherein the hole 5 may be of any geometrical shape. Ridge surface 1, ridge surface 2 and side surface 4 are made of metallic materials. Preferably, the portions on the ridge surface 1, ridge surface 2 and side surface 4 where the holes are provided are lined with light-transparent material. In addition, the three-dimensional metallic character further comprises a bottom plate connected to the side surface 4 to form a bottom cavity. Wherein, the shape of the bottom plate matches with the shape of the strokes of the character.

A light-emitting element is disposed within the bottom cavity, wherein the light-emitting element may be any one of LED lamp, neon lamp or filament lamp.

The three-dimensional character in the present application refers to characters in broad sense, generally known as Chinese characters, English letters, Arabic numerals, various symbols, geometric shapes and other characters.

When electrified, the body of the three-dimensional metallic character emits light. The emitted light is soft, and the shining character has strong stereoscopic and aesthetic impressions. The three-dimensional metallic character is an ideal product for advertising signboards and various shops, and meanwhile beautifies urban night scene. Since the three-dimensional metallic character of the present application is made of metallic material, the stereoscopic effect thereof is still eye-catching even during daytime without electrified. The three-dimensional metallic character provided herein is durable in use, excellent in artistry and exquisite in decorative effect.

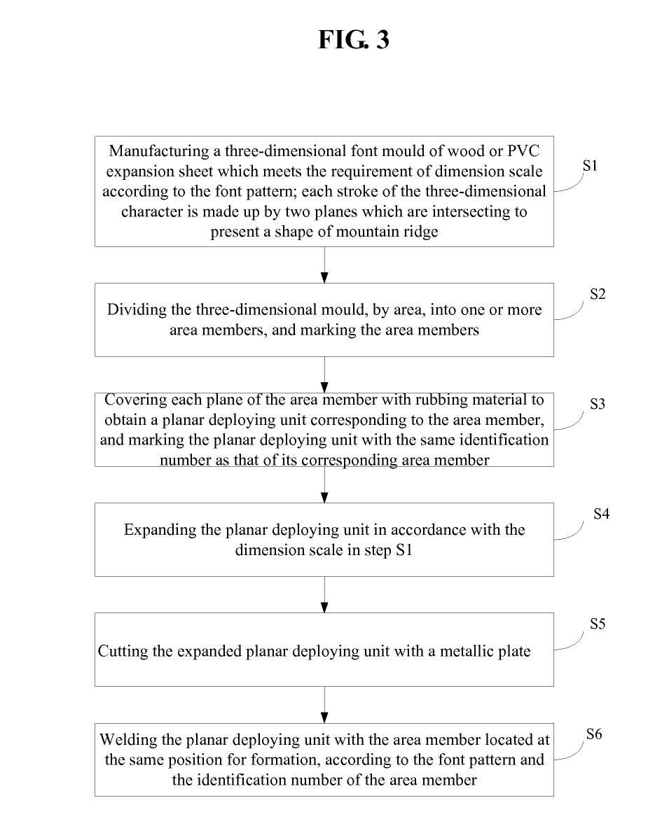

As shown in FIG. 3, the method of manufacturing the three-dimensional metallic character according to the embodiment of the present application comprises:

S1, manufacturing a three-dimensional font mould of wood or PVC expansion sheet which meets the requirement of dimension scale, according to the font pattern; each stroke of the three-dimensional font mould is made up by two planes which are intersecting to present a shape of mountain ridge;

S2, dividing the three-dimensional mould, by area, into one or more area members, and marking the area members; particularly, the mould may be divided in accordance with the strokes of the font;

S3, covering each plane of the area member with rubbing material to obtain a planar deploying unit corresponding to the area member, and marking the planar deploying unit with the same identification number as that of its corresponding area member; wherein, the rubbing material is sticky note or adhesive paper;

S4, expanding the planar deploying unit in accordance with the dimension scale instep S1;

S5, cutting the expanded planar deploying unit with a metallic plate; in this step, trepanning the planar deploying unit provided with presetting holes to form light-passing holes;

S6, welding the planar deploying unit with the area member located at the same position for formation, according to the font pattern and the identification number of the area member.

When the three-dimensional metallic character is electrified, the body of the three-dimensional character emits light. The emitted light is soft, and the shining character has strong stereoscopic and aesthetic impressions. The three-dimensional metallic character provided herein is an ideal product for advertising signboards and various shops, and meanwhile beautifies urban night scene. Since the three-dimensional metallic character of the present application is made of metallic material, the stereoscopic effect thereof is still eye-catching even during daytime without electrified. The three-dimensional metallic character provided herein is durable in use, excellent in artistry and exquisite in decorative effect.

### INDUSTRIAL APPLICABILITY

The three-dimensional metallic character and the manufacturing method thereof provided by the present application are novel in character structure and durable in use. When electrified in the night, the character presents eye-catching and artistic visual effect meanwhile beautifies urban night scene.

1. A three-dimensional metallic character, comprising a plurality of strokes, wherein:
each stroke of the three-dimensional metallic character is made up by two planes which are intersecting to present a shape of a mountain ridge;
a ridge portion of the mountain ridge constitutes a font;
a ridge surface forming the mountain ridge has holes thereon; and
a bottom of the ridge surface forming the mountain ridge is longitudinally connected to a side surface.

2. The three-dimensional metallic character according to claim 1, wherein the side surface is provided with holes.

3. The three-dimensional metallic character according to claim 1, further comprising a bottom plate, wherein the shape of the bottom plate matches with the shape of the strokes of the three-dimensional metallic character,. and the bottom plate is fixedly connected to the side surface to form a bottom cavity.

4. The three-dimensional metallic character according to claim 1, wherein the ridge surface and the side surface are made of metallic materials.

5. The three-dimensional metallic character according to claim 1, wherein locations where the holes are provided are lined with light-transparent material.

6. The three-dimensional metallic character according to claim 3, wherein a light-emitting element is disposed within the bottom cavity.

7. A method of manufacturing the three-dimensional metallic character in accordance with claim 1, the method comprising:
manufacturing a three-dimensional font mould of wood or PVC expansion sheet which meets the requirement of dimensional scale, according to the font pattern; each stroke of the three-dimensional font mould is made up by two planes which are intersecting to present the shape of the mountain ridge;
dividing the three-dimensional font mould, by area, into one or more area members, and marking the area members;
covering each plane of the area member with rubbing material to obtain a planar deploying unit corresponding to the area member, and marking the planar deploying unit with a same identification number as that of its corresponding area member;
expanding the planar deploying unit in accordance with the dimension scale in the manufacturing step;
cutting the expanded planar deploying unit with a metallic plate; and
welding the planar deploying unit with the area member located at the same position for formation, according to the font pattern and the identification number of the area member.

8. The method of manufacturing the three-dimensional metallic character according to claim 7, wherein the rubbing material is a sticky note or an adhesive paper.

9. The method of manufacturing the three-dimensional metallic character according to claim 7, wherein the cutting step includes trepanning the planar deploying unit to form holes.
